(19) United States
(12) Patent Application Publication
(10) Pub. No.: US 2025/0358496 A1
(43) Pub. Date: Nov. 20, 2025

(54) IMAGE PICKUP APPARATUS CAPABLE OF MAINTAINING HIGH APPEARANCE QUALITY OF HOUSED STATE OF DISPLAY UNIT WHILE SUPPRESSING DETERIORATION IN OPERABILITY WHEN OPENING OR CLOSING THE DISPLAY UNIT

(71) Applicant: CANON KABUSHIKI KAISHA, Tokyo (JP)

(72) Inventors: YUSUKE MOGI, Tokyo (JP); YUKO IRITANI, Tokyo (JP); KOICHI YUSA, Tokyo (JP); YUTA SUGAMOTO, Tokyo (JP)

(21) Appl. No.: 19/205,278

(22) Filed: May 12, 2025

(30) Foreign Application Priority Data
May 16, 2024 (JP) 2024-080071

(51) Int. Cl. H04N 23/53; G03B 17/56; H04N 23/51

(52) U.S. Cl. CPC H04N 23/531; G03B 17/563; H04N 23/51

(57) ABSTRACT

An image pickup apparatus that is capable of suppressing a deterioration in operability when opening or closing a display unit and is capable of maintaining a high appearance quality of a housed state of the display unit is provided. The image pickup apparatus includes an apparatus main body, and a display unit that has been attached to a rear surface side of the apparatus main body via a hinge having a first rotation axis and a second rotation axis that are perpendicular to each other. The apparatus main body includes a first housing section for housing the display unit, a second housing section for housing a battery, and a partition wall portion that isolates the first housing section and the second housing section. A holding mechanism for holding the display unit in the first housing section is provided on the partition wall portion and the display unit.

### BACKGROUND OF THE INVENTION

### Field of the Invention

The present invention relates to an image pickup apparatus equipped with a display unit.

### Description of the Related Art

There are image pickup apparatuses equipped with a display unit that is configured with a liquid crystal panel, an organic EL panel, or the like, and the display unit is generally attached to the rear surface of the image pickup apparatus via a hinge so as to be openable and closable. Japanese Laid-Open Patent Publication (kokai) No. 2009-290692 discloses a structure in which a holding means that holds a display unit in a closed state (in a tight contact state) relative to an image pickup apparatus is provided between the image pickup apparatus and the display unit. Specifically, when a locking claw provided on the image pickup apparatus is engaged with a recess portion provided on the display unit, an inclination of the display unit is corrected by an inclined surface of the locking claw sliding against an inclined surface of the recess portion, and the display unit is held in the closed state relative to an image pickup apparatus.

In the case where the display unit is made openable and closable by being supported at one side by a hinge, the own weight of the display unit tends to cause the display unit to be tilted so that the opposite side of an opening and closing axis is lowered. Here, in the structure disclosed in Japanese Laid-Open Patent Publication (kokai) No. 2009-290692, since the recess portion of the display unit is provided on the side surface on the opposite side of the opening and closing axis of the hinge, when the display unit is tilted, the position of the recess portion relative to the locking claw may shift, which may reduce operability when opening or closing the display unit. In addition, in the case where the display unit is tilted, the display unit rubs against a wall surface of a housing section of an image pickup apparatus main body, which is a main body of the image pickup apparatus, when the display unit is opened or closed, which also reduces the operability. Furthermore, when the display unit is tilted in a state of being housed in the image pickup apparatus main body, the appearance quality is impaired.

### SUMMARY OF THE INVENTION

The present invention provides an image pickup apparatus that is capable of suppressing a deterioration in operability when opening or closing a display unit and is capable of maintaining a high appearance quality of a housed state of the display unit.

Accordingly, the present invention provides an image pickup apparatus comprising an apparatus main body, and a display unit that has been attached to a rear surface side of the apparatus main body via a hinge having a first rotation axis and a second rotation axis that are perpendicular to each other. The apparatus main body comprises a first housing section for housing the display unit, a second housing section for housing a battery, and a partition wall portion that isolates the first housing section and the second housing section. A holding mechanism for holding the display unit in the first housing section is provided on the partition wall portion and the display unit.

Accordingly, the present invention provides an image pickup apparatus comprising a display unit that has been attached to a rear surface side of an apparatus main body via a hinge having two rotation axes that are perpendicular to each other. The apparatus main body comprises a housing section for housing the display unit, a wall portion that has a wall surface facing a side surface on a lower side of the display unit, which has been housed in the housing section, in a state where the image pickup apparatus is in a normal posture, a protrusion portion that protrudes from the wall surface toward a first direction from a bottom surface of the apparatus main body toward a top surface of the apparatus main body and is disposed movably in the first direction, and a biasing member that is configured to bias the protrusion portion toward the first direction. The display unit comprises a recess portion that is engaged with the protrusion portion in a state where the display unit has been housed in the housing section. In a state where the protrusion portion and the recess portion are engaged with each other, the display unit is biased by the biasing member via the protrusion portion in the first direction and toward a rear surface of the apparatus main body.

According to the present invention, it is possible to realize the image pickup apparatus that is capable of suppressing the deterioration in the operability when opening or closing the display unit and is capable of maintaining the high appearance quality of the housed state of the display unit.

Further features of the present invention will become apparent from the following description of exemplary embodiments with reference to the attached drawings.

### BRIEF DESCRIPTION OF THE DRAWINGS

FIG. 1A and FIG. 1B are external appearance perspective views of an image pickup apparatus according to an embodiment of the present invention.

FIG. 2A and FIG. 2B are external appearance perspective views that show the image pickup apparatus by changing a state of a rear monitor.

FIG. 3A and FIG. 3B are views that illustrate a locking claw that constitutes a monitor locking mechanism and its surrounding structure.

FIG. 4A and FIG. 4B are views that illustrate the movement of the monitor locking mechanism when the rear monitor is opened or closed.

FIG. 5A and FIG. 5B are views that show a standard housed state of the rear monitor.

FIG. 6A and FIG. 6B are sectional views taken along arrows MG-MG in FIG. 5A that show a housed state of the rear monitor.

FIG. 7 is a perspective view that shows a contact state between a corner portion of the rear monitor and the locking claw.

FIG. 8A and FIG. 8B are sectional views taken along the arrows MG-MG in FIG. 5A that show the monitor locking mechanism of the rear monitor.

FIG. 9 is an external appearance perspective view of the image pickup apparatus when viewed from the rear.

FIG. 10 is a partial enlarged view of the rear surface of the image pickup apparatus.

FIG. 11A nd FIG. 11B are views that illustrate attachment and detachment of a cable to and from an external connection terminal.

FIG. 12 is a side view that shows a positional relationship between the external connection terminal and a gripping portion operation member.

FIG. 13A is an external appearance perspective view of the image pickup apparatus, and FIG. 13B is a sectional view taken along arrows NA-NA in the external appearance perspective view of FIG. 13A.

### DESCRIPTION OF THE EMBODIMENTS

The present invention will now be described in detail below with reference to the accompanying drawings showing embodiments thereof.

Hereinafter, an embodiment of the present invention will be described in detail with reference to the accompanying drawings.

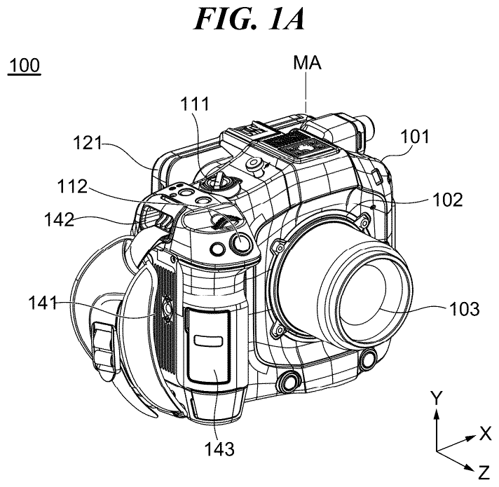

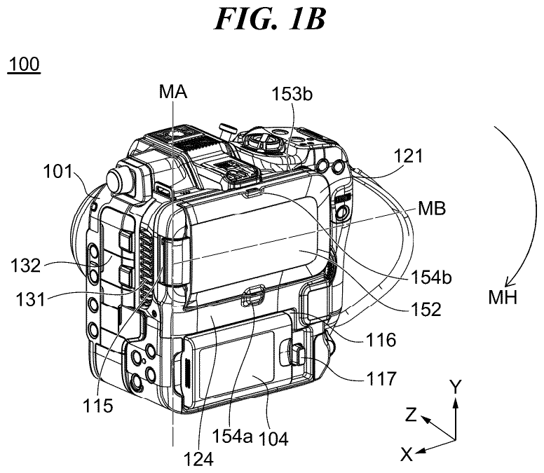

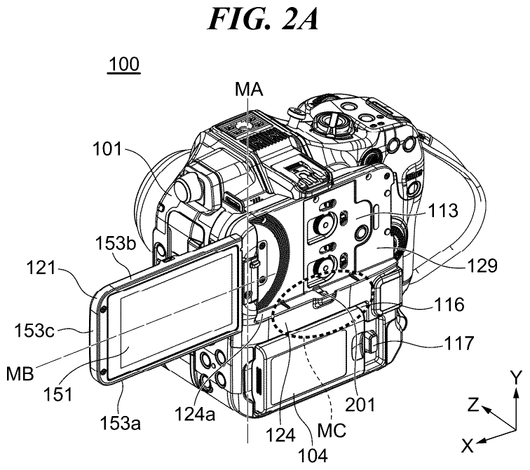

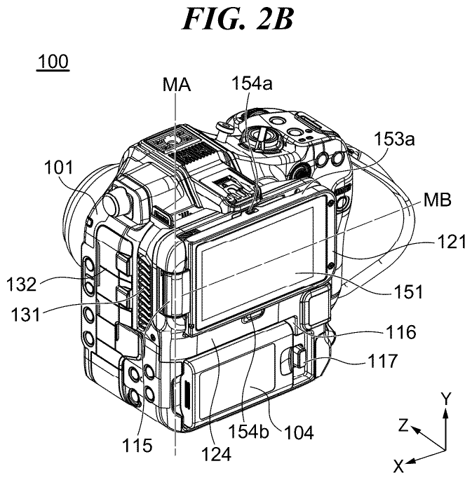

FIG. 1A and FIG. 1B are external appearance perspective views of an image pickup apparatus 100 according to the embodiment, and the image pickup apparatus 100 is viewed from different directions in FIG. 1A and FIG. 1B. For ease of description, as shown in FIG. 1A and FIG. 1B, three-dimensional orthogonal axes (X, Y, and Z axes) are defined. The Z axis is perpendicular to an image pickup surface of an image pickup device (not shown) installed inside the image pickup apparatus 100 (is parallel to an image pickup optical axis), and a direction from the image pickup apparatus 100 toward a subject (not shown) is defined as the positive direction (+Z), and a direction opposite to the positive direction (+Z) is defined as the negative direction (−Z). The X axis is parallel to a width direction of the image pickup apparatus 100, and a direction from left toward right when viewed from the front of the image pickup apparatus 100 (the +Z side) is defined as the positive direction (+X), and a direction opposite to the positive direction (+X) is defined as the negative direction (−X). The Y axis is parallel to a height direction of the image pickup apparatus 100, and a direction from the bottom surface of the image pickup apparatus 100 toward the top surface of the image pickup apparatus 100 is defined as the positive direction (+Y), and a direction opposite to the positive direction (+Y) is defined as the negative direction (−Y). It should be noted that a posture of the image pickup apparatus 100 shown in FIG. 1A and FIG. 1B, and FIG. 2A and FIG. 2B that will be described below (a posture in which the X axis and the Z axis are parallel to a horizontal plane and the +Y direction faces upward) is referred to as a normal posture.

The image pickup apparatus 100 includes a lens device 103, an apparatus main body 101, and a rear monitor 121. It should be noted that the apparatus main body 101 and the rear monitor 121 are distinguished from each other for the sake of convenience. A lens mount 102, to which and from which the lens device 103 is capable of being attached and detached, is disposed on the front surface of the image pickup apparatus 100. On the top surface of the image pickup apparatus 100, there are provided a power switch 111 for turning the power of the image pickup apparatus 100 on and off, and a recording button 112 for starting and stopping photographing (recording) still images and moving images (videos).

The rear monitor 121 (a display unit) and a battery chamber 116 (a battery housing section) are provided on the rear surface of the image pickup apparatus 100. The rear monitor 121 includes a liquid crystal panel, an organic EL panel, or the like, and displays still images and moving images that are photographed by the image pickup apparatus 100, menus for performing various kinds of settings of the image pickup apparatus 100, operating states, etc. Various types of batteries 104, which are each capable of supplying power to the image pickup apparatus 100, are capable of being attached to and detached from the battery chamber 116. A battery removal button 117, which serves as an operation member for removing the battery 104 that has been housed in the battery chamber 116, is provided near the battery chamber 116, and a user is able to remove the battery 104 that has been housed in the battery chamber 116 by pressing the battery removal button 117.

An air intake port 131, and a group of connection terminals (not shown due to a protective cover 132) for communicably connecting to an external device (not shown) are provided on the right side surface of the image pickup apparatus 100. In addition, a gripping portion 141 that is a portion where the user grips the image pickup apparatus 100 in his/her right hand, an air exhaust port 142, and a recording medium insertion portion 143 are provided on the left side surface of the image pickup apparatus 100. A cooling unit (not shown), which includes a cooling duct (not shown), a fan (not shown), etc., is disposed inside the image pickup apparatus 100, and end portions of the cooling duct serve as the air intake port 131 and the air exhaust port 142.

In addition, on the external appearance surface of the image pickup apparatus 100, various kinds of operation buttons and dials for performing the setting of the image pickup apparatus 100 and performing photographing operations of the image pickup apparatus 100 are provided. In addition, although not shown, a main control substrate that performs overall control of the image pickup apparatus 100 and image processing, an image pickup substrate on which the image pickup device (an image sensor) that converts incident light from the lens device 103 into electrical signals has been mounted, various types of sensors, and the like are provided inside the image pickup apparatus 100.

Next, various usage patterns of the rear monitor 121 will be described with reference to FIG. 1B, FIG. 2A, and FIG. 2B. FIG. 2A is a perspective view of the image pickup apparatus 100 when the rear monitor 121 is in a fully open state, and FIG. 2B is a perspective view of the image pickup apparatus 100 when the rear monitor 121 is in an inverted-and-housed state. It should be noted that FIG. 1B is a perspective view of the image pickup apparatus 100 when the rear monitor 121 is in a standard housed state in terms of the state of the rear monitor 121.

The rear monitor 121 is a so-called vari-angle monitor that is configured to be rotatable around a hinge 115, which has two axes perpendicular to each other that are an opening and closing axis MA substantially parallel to the Y axis and a rotation axis MB perpendicular to the opening and closing axis MA, as a central axis. The rear monitor 121 is rotatable around the opening and closing axis MA as a central axis between a housed position shown in FIG. 1B and an open position in which the rear monitor 121 is pulled out from the housed position.

The rear monitor 121 has a substantially rectangular shape when viewed from a direction perpendicular to the opening and closing axis MA and the rotation axis MB. The rear monitor 121 has a display screen 151 in which the liquid crystal panel, the organic EL panel, or the like has been embedded, a rear surface portion 152 opposite the display screen 151, a long-side side surface 153a, a long-side side surface 153b, and a short-side side surface 153c. The long-side side surface 153a, the long-side side surface 153b, and the short-side side surface 153c are formed between the display screen 151 and the rear surface portion 152. The long-side side surface 153a is provided with a claw receiver 154a, and the long-side side surface 153b is provided with a claw receiver 154b.

The standard housed state of FIG. 1B is a state in which the rear surface portion 152 of the rear monitor 121 is exposed on the −Z side of the apparatus main body 101 and the display screen 151 faces the rear surface of the apparatus main body 101. The standard housed state can be said to be a state suitable for housing or transporting the image pickup apparatus 100 because the display screen 151 is not exposed to the external appearance (the outside) and therefore damage to the display screen 151 is capable of being prevented.

When the rear monitor 121 is rotated approximately 180 degrees from the standard housed state around the opening and closing axis MA and is brought out to the +X side of the apparatus main body 101, as shown in FIG. 2A, the rear monitor 121 becomes the fully open state in which the display screen 151 faces the −Z side. The fully open state is an example of a state in which the rear monitor 121 is in the open position, and with the rear monitor 121 in the fully open state, the user is able to check a live view image displayed on the display screen 151 and is also able to perform photographing of still images and moving images (videos) while checking the subject.

In the process of transitioning the rear monitor 121 from the state of FIG. 1B to the state of FIG. 2A, a rear surface operation system 113 provided on the rear surface of the apparatus main body 101 is exposed to the external appearance (the outside). The rear surface operation system 113 includes buttons, switches, etc., and the user is able to operate the rear surface operation system 113 to perform various kinds of settings of the image pickup apparatus 100 and to cause the image pickup apparatus 100 to perform a desired operation.

When the rear monitor 121, which is in the fully open state, is rotated approximately 180 degrees around the rotation axis MB and then rotated approximately 180 degrees around the opening and closing axis MA, as shown in FIG. 2B, the rear monitor 121 becomes the inverted-and-housed state in which the display screen 151 is exposed to the external appearance (the outside) on the rear surface side of the apparatus main body 101. In the inverted-and-housed state, similar to the fully open state, the user is able to check various kinds of images displayed on the display screen 151, but is not able to operate the rear surface operation system 113. It should be noted that a space in which the rear monitor 121 is disposed on the rear surface of the apparatus main body 101 when the rear monitor 121 is in the standard housed state or the inverted-and-housed state is referred to as “a monitor housing section 129”.

Next, a configuration for stably holding the rear monitor 121 in the monitor housing section 129 in the standard housed state and the inverted-and-housed state (hereinafter, referred to as “a monitor locking mechanism”) will be described. The main components of the monitor locking mechanism (a holding mechanism) include a monitor locking claw 201 (a protrusion portion) that is provided on the apparatus main body 101, and the claw receivers 154a and 154b (recess portions) that are provided on the rear monitor 121. The rear monitor 121 is stably held in the monitor housing section 129 by engaging one of the claw receivers 154a and 154b with the monitor locking claw 201.

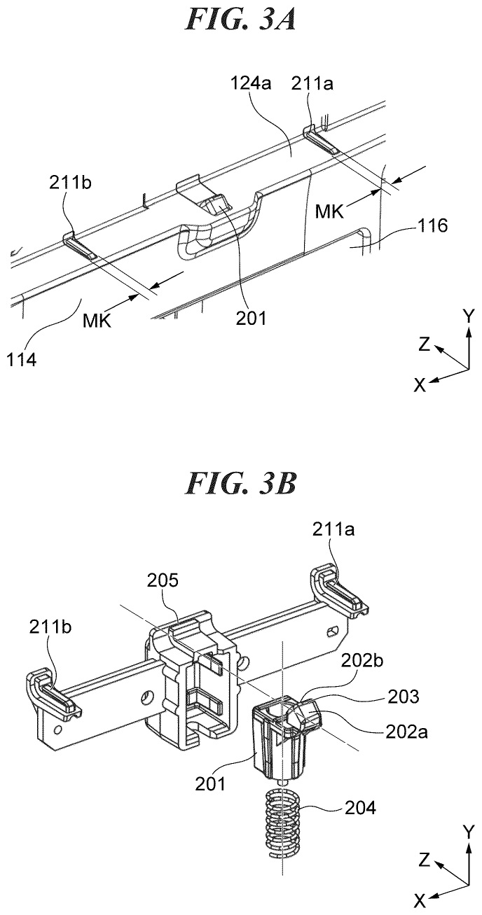

FIG. 3A and FIG. 3B are views that illustrate the monitor locking claw 201 that constitutes the monitor locking mechanism and its surrounding structure. Specifically, FIG. 3A is an enlarged view of a dashed line portion MC shown in FIG. 2A. FIG. 3B is an exploded perspective view that shows the internal structure of the monitor locking mechanism on the apparatus main body 101 side, and shows a state in which a rear surface cover 114 that constitutes the rear surface of the apparatus main body 101 has been removed.

The monitor locking mechanism includes, as components in the apparatus main body 101, the monitor locking claw 201, a spring 204, a claw holding member 205, and the rear surface cover 114. The rear surface cover 114 is provided with a partition wall portion 124 (see FIG. 1B) that isolates (separates) the monitor housing section 129 and the battery chamber 116 in the Y direction. The monitor locking claw 201 is disposed so as to protrude from a part of a top surface 124a (a wall surface on the monitor housing section 129 side (the +Y side)) of the partition wall portion 124 toward the +Y side. The claw holding member 205 is fixed to the rear surface cover 114 with screws or the like (not shown).

The spring 204 is an example of a biasing member that biases the monitor locking claw 201 toward the +Y direction. The monitor locking claw 201 is held by the claw holding member 205 in a state where the monitor locking claw 201 has been biased in the Y direction by the spring 204, and is movable in the Y direction, which is a direction in which the spring 204 expands and contracts.

The monitor locking claw 201 has an inclined surface 202a and an inclined surface 202b that protrude toward the +Y direction. The boundary (a ridge line portion) between the inclined surface 202a and the inclined surface 202b may be formed continuously by a smooth curved surface, or an upper surface 203 may be formed between the inclined surface 202a and the inclined surface 202b. Since the monitor locking claw 201 slides against the rear monitor 121, it is preferred that the monitor locking claw 201 is made of a material with good sliding, such as POM.

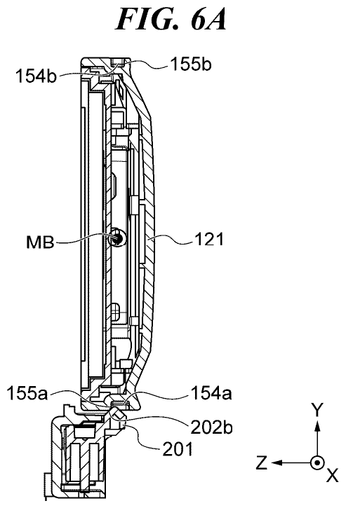

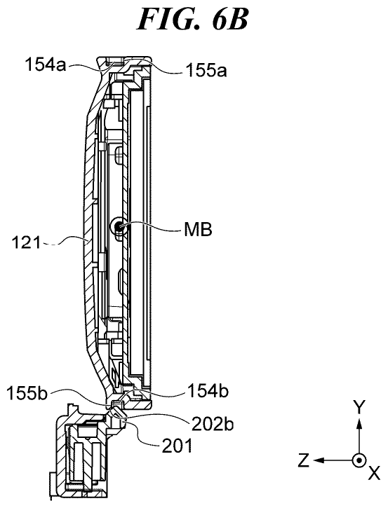

As shown in FIG. 2A and FIG. 2B, the monitor locking mechanism includes, as components in the rear monitor 121, the claw receiver 154a provided on the long-side side surface 153a and the claw receiver 154b provided on the long-side side surface 153b, which have each a concave shape. Although details will be described below, the claw receiver 154a has an inner wall surface 155a (see FIG. 6A) that abuts on the inclined surface 202b of the monitor locking claw 201 in the standard housed state and the inverted-and-housed state, and the claw receiver 154b has an inner wall surface 155b (see FIG. 6B) that abuts on the inclined surface 202b of the monitor locking claw 201 in the standard housed state and the inverted-and-housed state.

In the present embodiment, the hinge 115 for rotating the rear monitor 121 is provided on one of two short-side side surfaces of the rear monitor 121, which is configured to have a substantially rectangular shape when viewed from the Z direction perpendicular to the display screen 151. In this case, the components in the rear monitor 121 of the monitor locking mechanism are provided on the long-side side surface 153a and the long-side side surface 153b of the rear monitor 121. In addition, the components in the apparatus main body 101 of the monitor locking mechanism are provided in a portion between the monitor housing section 129 and the battery chamber 116, that is, in the partition wall portion 124. As a result, compared to providing the monitor locking mechanism on the short-side side surface 153c of the rear monitor 121, it is possible to prevent the image pickup apparatus 100 from becoming large in size in the width direction (the X direction).

It should be noted that in the present embodiment, the monitor locking mechanism is disposed between the battery chamber 116 and the rear monitor 121, but the present invention is not limited to this, and the monitor locking mechanism may be disposed at a position opposite the battery chamber 116 with the rear monitor 121 as a reference. As a result, it is possible to prevent the image pickup apparatus 100 from becoming large in size in the width direction.

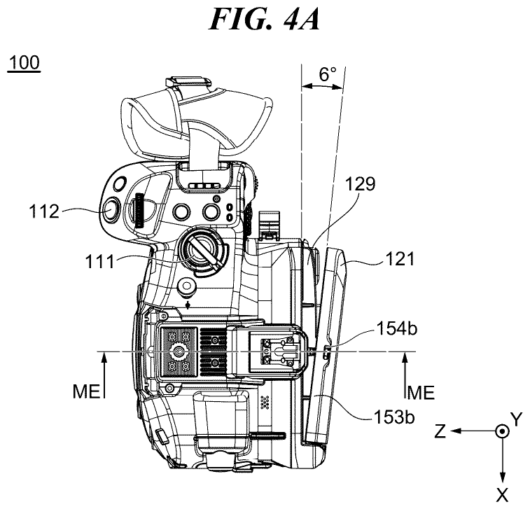

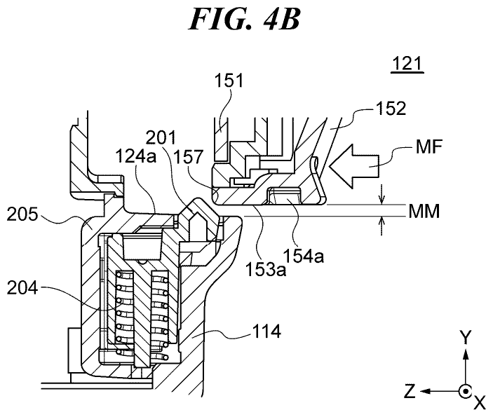

Next, the operation of the monitor locking mechanism when the rear monitor 121, which is in the open position, is rotated to the housed position will be described. FIG. 4A and FIG. 4B are views that illustrate the movement of the monitor locking mechanism when the rear monitor 121 is opened or closed. As an example of a state in which the rear monitor 121 is in the middle of being opened or closed, FIG. 4A shows a top view of the image pickup apparatus 100 in a state in which the rear monitor 121 is opened 6 degrees from the standard housed state around the opening and closing axis MA. In addition, FIG. 4B is a sectional view taken along arrows ME-ME in FIG. 4A, and shows the configuration around the monitor locking mechanism. It should be noted that in FIG. 4B, hatching display is omitted for cross sections of some of the components.

When the rear monitor 121, which is in the open position, is pushed in a direction of an arrow MF shown in FIG. 4B (an arrow MF direction) (that is, a direction in which the rear monitor 121 is closed), a corner portion 157 of the rear monitor 121 abuts on the inclined surface 202a of the monitor locking claw 201 and then pushes the monitor locking claw 201 in the −Y direction. Next, when the rear monitor 121 is further pushed in the arrow MF direction, the side surface on the lower side (the −Y side) of the rear monitor 121 (the long-side side surface 153a in the case of FIG. 4A and FIG. 4B) slides against the upper surface 203 of the monitor locking claw 201, and then the claw receiver 154a is engaged with the monitor locking claw 201. In this way, the rear monitor 121 is housed in the monitor housing section 129 in the standard housed state.

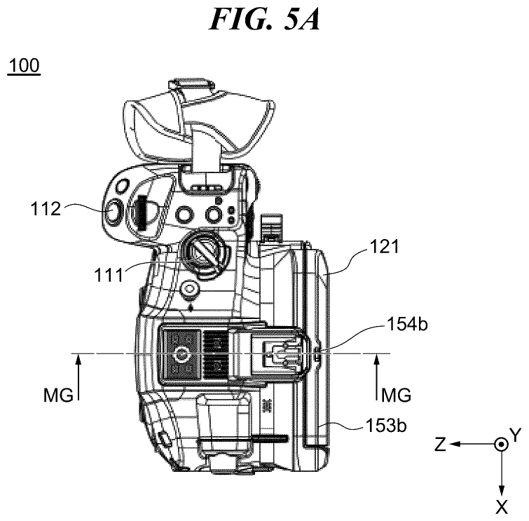

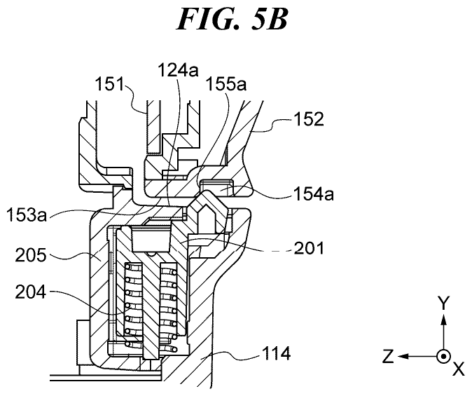

FIG. 5A and FIG. 5B are views that show the rear monitor 121, which is in the standard housed state. FIG. 5A shows a side view of the image pickup apparatus 100 when the rear monitor 121 is in the standard housed state. FIG. 5B shows a sectional view of the members around the monitor locking mechanism taken along arrows MG-MG in FIG. 5A.

When the rear monitor 121 is in the standard housed state, the monitor locking claw 201 and the claw receiver 154a are engaged with each other. At this time, as shown in FIG. 5B, the spring 204 biases the monitor locking claw 201 toward the +Y direction, causing the inclined surface 202b of the monitor locking claw 201 to abut on an opening end on the +Z side of the claw receiver 154a (a corner portion formed by the inner wall surface 155a on the +Z side and the long-side side surface 153a). As a result, the rear monitor 121 is pressed not only in the +Y direction, but also toward the rear surface of the apparatus main body 101 (in the +Z direction).

Here, since the rear monitor 121 is capable of being opened and closed by being supported at one side by the hinge 115, the own weight of the rear monitor 121 tends to cause the rear monitor 121 to be tilted so that the short-side side surface 153c side is lowered toward the −Y side. In order to deal with this issue, in the present embodiment, a pressing force generated by the spring 204 toward the +Y direction against the rear monitor 121 produces the effect of correcting tilting of the rear monitor 121 within the XY plane. Therefore, the rear monitor 121 is held in the monitor housing section 129 in a state in which the tilting due to the own weight of the rear monitor 121 has been suppressed, and this suppresses a deterioration in the appearance quality of the image pickup apparatus 100 in the housed state. In addition, a force of the spring 204 pressing the monitor locking claw 201 toward the +Z direction presses the rear monitor 121 against the apparatus main body 101, thereby producing the effect of reducing wobbling of the rear monitor 121 around the opening and closing axis MA. In other words, it becomes possible to hold the rear monitor 121 in the monitor housing section 129 in a stable state.

The only difference between the standard housed state and the inverted-and-housed state of the rear monitor 121 is whether the claw receiver with which the monitor locking claw 201 is engaged is the claw receiver 154a or the claw receiver 154b. Therefore, even in the inverted-and-housed state, the rear monitor 121 is locked by the monitor locking mechanism in the same manner as in the standard housed state, and is held in the monitor housing section 129 in the inverted-and-housed state.

Next, the correction of the tilting of the rear monitor 121 by the monitor locking claw 201 will be described by using the standard housed state as an example. It should be noted that since the correction of the tilting of the rear monitor 121 in the inverted-and-housed state is the same as the correction of the tilting of the rear monitor 121 in the standard housed state, the description thereof will be omitted.

As described above, the support structure of the rear monitor 121 is a cantilever structure with the hinge 115 as a fulcrum for the apparatus main body 101. Therefore, when the rear monitor 121 is in the standard housed state, the rear monitor 121 may tilt in a direction indicated by an arrow MH shown in FIG. 1B due to the own weight of the rear monitor 121, and the long-side side surface 153a of the rear monitor 121 may come close to the top surface 124a of the partition wall portion 124 of the rear surface cover 114. As a result, as shown in FIG. 4B, a gap MM in the Y direction between the long-side side surface 153a and the top surface 124a becomes narrower, which may result in a deterioration in the appearance quality in the standard housed state.

In order to deal with this issue, in the image pickup apparatus 100, the monitor locking claw 201 is caused to protrude from the top surface 124a of the rear surface cover 114 toward the +Y direction. In other words, the direction in which the monitor locking claw 201 protrudes is substantially parallel to the opening and closing axis MA of the hinge 115 and is substantially perpendicular to the long-side side surface 153a. Therefore, even in the case where the rear monitor 121, which is open, is pushed in the arrow MF direction shown in FIG. 4B in a state where the long-side side surface 153a and the top surface 124a are close to each other, the position in the Y direction of the rear monitor 121 is adjusted as follows. In other words, after the corner portion 157 of the rear monitor 121 abuts on the inclined surface 202a of the monitor locking claw 201, the rear monitor 121 is lifted in the +Y direction so as to slide along the inclined surface 202a. As a result, as the gap MM between the long-side side surface 153a and the top surface 124a increases, the rear monitor 121 rotates with the hinge 115 as a fulcrum. Thereafter, the monitor locking claw 201 and the claw receiver 154a are engaged with each other, and the rear monitor 121 is held in the monitor housing section 129 in the standard housed state. In the standard housed state, a biasing force of the spring 204 causes the monitor locking claw 201 to lift the rear monitor 121 to a predetermined position in the +Y direction. In this way, the tilting of the rear monitor 121 during the housing operation of the rear monitor 121 and in the housed state is corrected.

Next, a configuration for smoothly performing the opening and closing operation of the rear monitor 121 will be described with reference to the already-described drawings. When the rear monitor 121 is in the open position, the biasing force of the spring 204 is not applied to the rear monitor 121 via the monitor locking claw 201. Therefore, in the case where the rear monitor 121 is in the open position, since the rear monitor 121 may be tilted as described above due to the own weight of the rear monitor 121, when the rear monitor 121 is rotated to the housed position in this state, there is a possibility that the rear monitor 121 and the top surface 124a of the partition wall portion 124 will rub against each other. If such rubbing occurs, the user is likely to feel uncomfortable when operating the rear monitor 121.

In order to avoid the occurrence of such an issue, as shown in FIG. 3B, on the top surface 124a of the partition wall portion 124, strip-shaped sliding ribs 211a and 211b, which protrude toward the +Y direction, are provided at a predetermined interval on the −X side and the +X side of the monitor locking claw 201. The sliding ribs 211a and 211b may be formed by integral molding with the rear surface cover 114, or may be formed as separate members from the rear surface cover 114 and attached to the rear surface cover 114. In the case where the rear surface cover 114, and the sliding ribs 211a and 211b are configured (formed) with separate members (separate components), it is possible to perform surface treatment such as painting separately for the rear surface cover 114, and the sliding ribs 211a and 211b. For example, by painting the rear surface cover 114 while leaving the sliding ribs 211a and 211b unpainted, the sliding ribs 211a and 211b are capable of being made to have a surface state that allows easy sliding (a surface state with a low frictional force). For example, it is preferable to use a material with a small friction coefficient, such as POM, for the sliding ribs 211a and 211b.

As shown in FIG. 3B, the sliding ribs 211a and 211b may be formed integrally with the claw holding member 205. A width MK of the sliding ribs 211a and 211b in the X direction is, for example, 1 mm, and the amount of protrusion from the top surface 124a of the partition wall portion 124 is, for example, 0.5 mm. The longitudinal direction of the sliding ribs 211a and 211b is substantially parallel to a direction in which the sliding ribs 211a and 211b slide against the rear monitor 121 when the rear monitor 121 is opened or closed, that is, is substantially parallel to the Z direction.

Even if the rear monitor 121 is tilted in the direction indicated by the arrow MH shown in FIG. 1B, when the user opens or closes the rear monitor 121, the area on the top surface 124a of the partition wall portion 124 where the long-side side surface 153a of the rear monitor 121 slides is limited to the sliding ribs 211a and 211b. Therefore, a frictional force generated by the opening and closing operation of the rear monitor 121 is smaller than that in the case where the sliding ribs 211a and 211b are not provided. In this way, even in the case where the rear monitor 121 is tilted in the direction indicated by the arrow MH shown in FIG. 1B, the user is able to open or close the rear monitor 121 without feeling uncomfortable.

It should be noted that when the rear monitor 121 is closed, the long-side side surface 153a starts to slide against the sliding rib 211b and then also slides against the sliding rib 211a. Conversely, when the rear monitor 121 in the standard housed state is opened, the long-side side surface 153a first slides against the sliding rib 211a more than the sliding rib 211b, and then slides only against the sliding rib 211b. In this way, by arranging the two sliding ribs 211a and 211b at the predetermined interval in the X direction so as to sandwich the monitor locking claw 201, a wide slidable area is capable of being formed when the rear monitor 121 is opened or closed.

Next, the claw receivers 154a and 154b, which are the main components of the monitor locking mechanism, will be described. As shown in FIG. 1A, FIG. 1B, FIG. 2A, and FIG. 2B, the claw receiver 154a is provided on the long-side side surface 153a of the rear monitor 121, and the claw receiver 154b is provided on the long-side side surface 153b of the rear monitor 121. The rear monitor 121 is capable of being housed in the standard housed state by engaging the claw receiver 154a with the monitor locking claw 201, and in the inverted-and-housed state by engaging the claw receiver 154b with the monitor locking claw 201.

FIG. 6A is a sectional view taken along the arrows MG-MG shown in FIG. 5A, with the rear monitor 121, which is in the standard housed state. FIG. 6B is a cross section taken at the same position as that of the arrows MG-MG shown in FIG. 5A, and is a sectional view when the rear monitor 121 is in the inverted-and-housed state. It should be noted that in FIG. 6A and FIG. 6B, hatching display is omitted for cross sections of some of the components.

The inner wall surface 155a of the claw receiver 154a and the inner wall surface 155b of the claw receiver 154b are provided at positions that are approximately point-symmetric with respect to the rotation axis MB of the hinge 115 (when viewed from an axial direction of the rotation axis MB) within the YZ plane. As a result, when the rear monitor 121 is housed, the claw receivers 154a and 154b are capable of coming into contact with the monitor locking claw 201 in the same positional relationship.

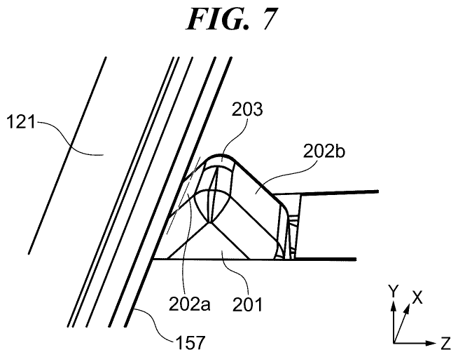

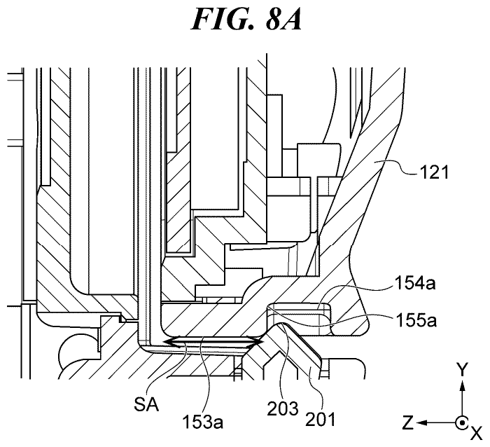

Next, the operation of the monitor locking claw 201 by the corner portion 157 of the rear monitor 121 when the rear monitor 121 is opened or closed will be described. As described with reference to FIG. 4A and FIG. 4B, when the rear monitor 121, which is open, is closed, the corner portion 157 of the rear monitor 121 comes into contact with the inclined surface 202a of the monitor locking claw 201. FIG. 7 is a perspective view that shows a state in which the corner portion 157 comes into contact with the inclined surface 202a of the monitor locking claw 201 when the rear monitor 121 is closed. In this case, the inclined surface 202a of the monitor locking claw 201 is provided so as to be approximately parallel to the corner portion 157 of the rear monitor 121 as shown by an alternate long and short dash line. In other words, the inclined surface 202a of the monitor locking claw 201 is not provided parallel to the X axis. Therefore, the inclined surface 202a of the monitor locking claw 201 comes into line contact with the corner portion 157 of the rear monitor 121, but does not come into contact with the corner portion 157 of the rear monitor 121 at a single point. As a result, when housing the rear monitor 121, wear due to contact between the corner portion 157 of the rear monitor 121 and the monitor locking claw 201 is unlikely to occur, and since the sticking due to the wear is capable of being reduced, it becomes possible to smoothly close the rear monitor 121.

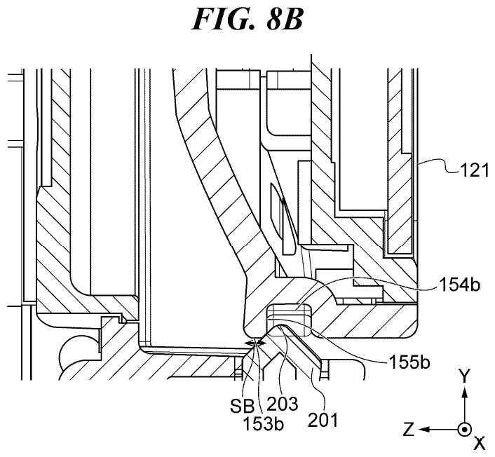

Next, the configuration of the monitor locking mechanism in the standard housed state and its surrounding parts will be described. FIG. 8A is a sectional view taken along the arrows MG-MG shown in FIG. 5A, showing the configuration of the monitor locking mechanism in the standard housed state and its surrounding parts. FIG. 8B is a sectional view taken at the same position as FIG. 8A, showing the configuration of the monitor locking mechanism in the inverted-and-housed state and its surrounding parts. It should be noted that in the sectional views of FIG. 8A and FIG. 8B, hatching display is omitted for cross sections of some of the components.

When the rear monitor 121 is opened or closed, the monitor locking claw 201 is pushed in the −Y direction when the monitor locking claw 201 abuts on the rear monitor 121, and the upper surface 203 of the monitor locking claw 201 slides against the long-side side surface 153a (or the long-side side surface 153b). At this time, the length of the area in which the upper surface 203 of the monitor locking claw 201 slides against the long-side side surface 153a is different from the length of the area in which the upper surface 203 of the monitor locking claw 201 slides against the long-side side surface 153b. Specifically, as shown in FIG. 8A and FIG. 8B, an arrow SB indicating the length over which the monitor locking claw 201 slides when the rear monitor 121 is in the inverted-and-housed state is shorter than an arrow SA indicating the length over which the monitor locking claw 201 slides when the rear monitor 121 is in the standard housed state. In this way, by reducing the thickness of the rear monitor 121 in the direction perpendicular to the display screen 151 and reducing unnecessary portions of the rear surface portion 152 by chamfering or the like, the miniaturization of the image pickup apparatus 100 in the standard housed state has been realized.

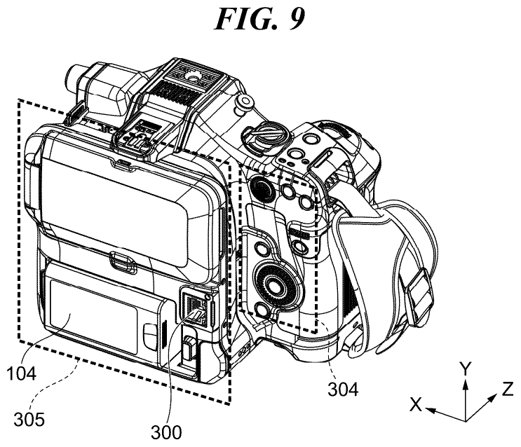

Next, an external connection terminal will be described. FIG. 9 is an external appearance perspective view of the image pickup apparatus 100 when viewed from the rear. On the rear surface of the image pickup apparatus 100, in addition to the rear monitor 121, the battery chamber 116, etc., an external connection terminal 300 is provided. It should be noted that for example, in FIG. 2A and FIG. 2B, the external connection terminal 300 is protected by a cap and is not visible on the external appearance (from the outside).

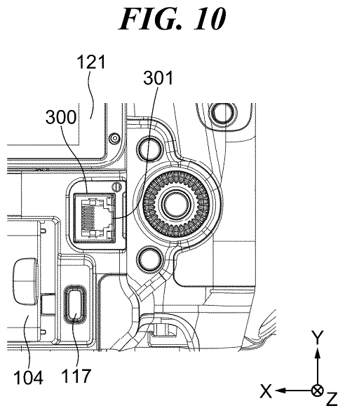

FIG. 10 is a partial enlarged view of the rear surface of the image pickup apparatus 100. FIG. 10 shows a positional relationship between the external connection terminal 300, the rear monitor 121, the monitor housing section 129, the battery 104, the battery chamber 116, and the battery removal button 117.

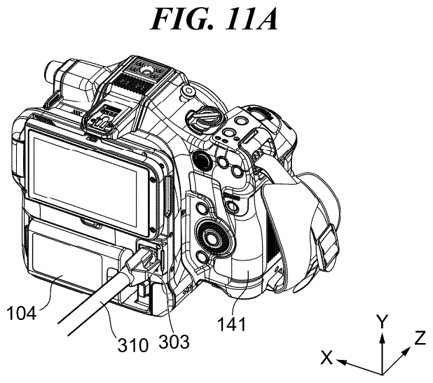

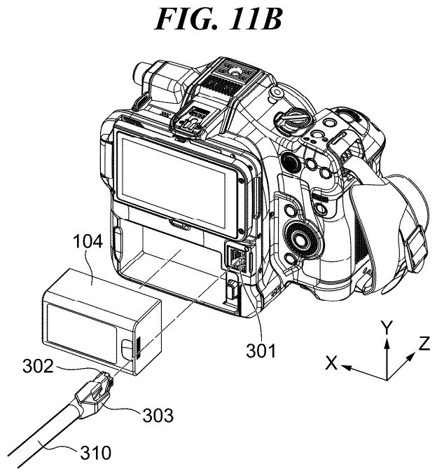

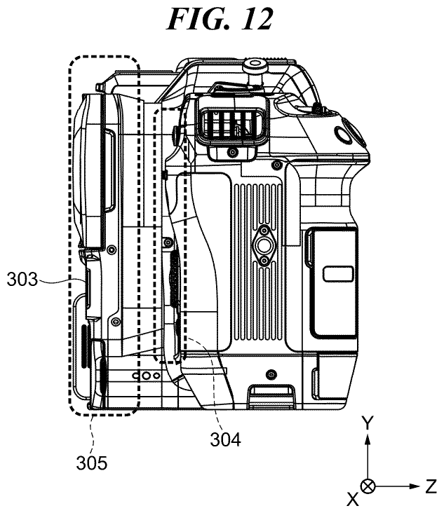

FIG. 11A is a perspective view that shows a state in which an interface cable 310 (hereinafter, referred to as “a cable 310”) has been attached to the external connection terminal 300. FIG. 11B is a perspective view that schematically shows how the cable 310 is attached to and detached from the external connection terminal 300. FIG. 12 is a side view that shows a positional relationship between the external connection terminal 300 and a gripping portion operation member 304.

The external connection terminal 300 has a connector locking portion 301. A connector 302 and a connector locking claw 303 are provided at the tip of the cable 310. The cable 310 is, for example, an Ethernet cable that communicably connects the image pickup apparatus 100 to an external device (not shown). When the connector 302 is attached to the external connection terminal 300, the connector locking claw 303 is engaged with the connector locking portion 301, thereby preventing the connector 302 from being unintentionally removed by the user. In the state shown in FIG. 11A in which the connector 302 has been attached to the external connection terminal 300, the connector 302 is capable of being removed from the external connection terminal 300 by pulling the cable 310 in the −Z direction while pushing the connector locking claw 303 in the +X direction.

With respect to the external connection terminal 300, the battery chamber 116 is disposed in the +X direction, the battery removal button 117 is disposed in the −Y direction, and the monitor housing section 129 is disposed in the +Y direction. On the other hand, the connector locking portion 301 is disposed in the −X direction with respect to the external connection terminal 300, which is different from the battery chamber 116, the battery removal button 117, and the monitor housing section 129. In addition, the gripping portion operation member 304, which is one of a plurality of operation portions included in the image pickup apparatus 100, is provided on the rear surface of the gripping portion 141. A projection portion 305 that projects in the −Z direction is formed adjacent to the gripping portion operation member 304 on the +X side of the gripping portion operation member 304, and the external connection terminal 300 is disposed on the top surface of the projection portion 305.

As a result, it is possible to easily attach and detach the cable 310 without lowering the visibility and the operability of the rear monitor 121, the operability of the rear surface operation system 113, the battery removal button 117, and the gripping portion operation member 304, and the ease of attaching and detaching the battery 104. In addition, the rear monitor 121, the rear surface operation system 113, the battery chamber 116, the battery removal button 117, the gripping portion operation member 304, and the external connection terminal 300 are efficiently disposed, thereby realizing the miniaturization of the image pickup apparatus 100.

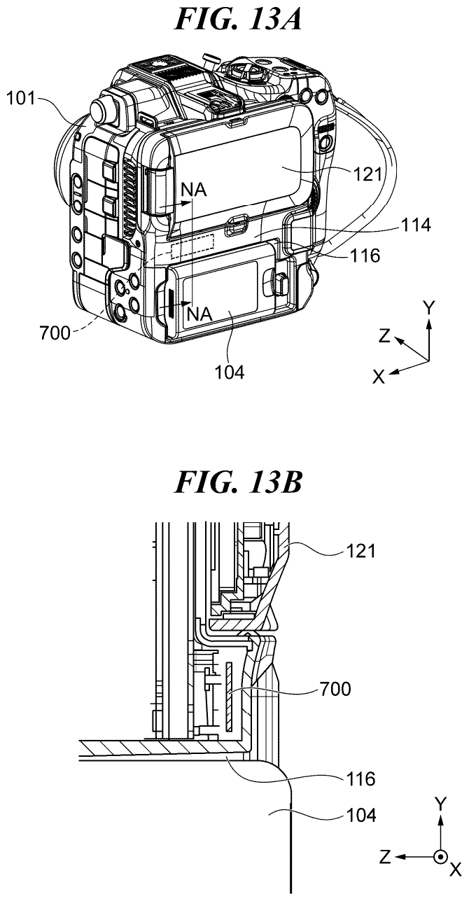

Next, a wireless antenna (a wireless antenna substrate) disposed on the rear surface of the image pickup apparatus 100 will be described. FIG. 13A is an external appearance perspective view of the image pickup apparatus 100 when viewed from the rear. FIG. 13B is a sectional view taken along arrows NA-NA shown in FIG. 13A. It should be noted that in the sectional view of FIG. 13B, hatching display is omitted for cross sections of some of the components.

A wireless antenna substrate 700, on which an antenna has been formed as a transmitting and receiving means for wirelessly communicating with an external device directly or via a network, is disposed between the battery chamber 116 in the apparatus main body 101 and the housed position of the rear monitor 121 (is disposed on the inside of the partition wall portion 124). The wireless antenna substrate 700 is disposed so that its substrate surface is perpendicular to the Z axis, and is electrically connected to the control substrate (not shown) inside the apparatus main body 101.

The rear surface cover 114 also serves as an exterior member that covers the wireless antenna substrate 700. The rear surface cover 114 is made of a non-conductive resin material and does not impede communication. In addition, although the battery chamber 116 is formed in the rear surface cover 114, a contact point, which electrically connects the battery 104 and the apparatus main body 101 when the battery 104 has been attached, is exposed to the outside through a hole provided in the battery chamber 116. Here, since the contact point is a movable member held by a spring so as to be moved in and out when the battery 104 is attached or detached, there is a possibility that the contact point may come into contact with the battery chamber 116. Therefore, the battery chamber 116 must be made of a non-conductive resin material. In the present embodiment, the rear surface cover 114 including the battery chamber 116 is formed from (is made of) a non-conductive resin material, and the rear surface cover 114 is also used as a cover for covering the wireless antenna substrate 700, making it possible to reduce the number of parts.

As described above, the rear monitor 121 is a vari-angle monitor. Therefore, when the rear monitor 121 is rotated around the opening and closing axis MA, the rear monitor 121 does not move in the up-and-down direction (the Y direction). Therefore, no matter where the rear monitor 121 is located, the rear monitor 121 will not overlap with the wireless antenna substrate 700 in the Z direction, and therefore the rear monitor 121 will not impede communication via the wireless antenna substrate 700. It is also necessary to dispose the monitor locking mechanism without interfering with the arrangement of the external connection terminal 300 and the wireless antenna substrate 700. From this viewpoint, it is preferable that the monitor locking mechanism is disposed at a position that divides a long side of the monitor housing section 129 approximately equally in a length direction of the monitor housing section 129 (a position where the ME-ME cross section crosses the claw receivers 154a and 154b).

Although the present invention has been described above in detail based on its preferred embodiments, the present invention is not limited to these specific embodiments, and the present invention also includes various forms without departing from the gist of the present invention. Furthermore, each of the above-described embodiments merely shows one embodiment of the present invention, and each embodiment can be appropriately combined.

For example, in the above embodiment, the monitor locking mechanism is provided by utilizing the space between the monitor housing section 129 and the battery chamber 116, but the monitor locking mechanism is also capable of being applied to an image pickup apparatus that does not include a battery chamber. For example, a protrusion portion corresponding to the partition wall portion 124 may be provided on the lower side of the rear monitor 121 in the housed position, and the monitor locking mechanism may be provided on the protrusion portion. In addition, even in the case where an image pickup apparatus has nothing on the lower side of the rear monitor 121 in the housed position, if a vertical position grip is capable of being attached to the bottom surface of the image pickup apparatus, a portion corresponding to the partition wall portion 124 may be provided on the vertical position grip, and then the monitor locking mechanism may be further provided at the portion corresponding to the partition wall portion 124.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-080071, filed on May 16, 2024, which is hereby incorporated by reference herein in its entirety.

What is claimed is:

1. An image pickup apparatus comprising:
an apparatus main body; and
a display unit that has been attached to a rear surface side of the apparatus main body via a hinge having a first rotation axis and a second rotation axis that are perpendicular to each other, and
wherein the apparatus main body comprises
a first housing section for housing the display unit;
a second housing section for housing a battery; and
a partition wall portion that isolates the first housing section and the second housing section, and
a holding mechanism for holding the display unit in the first housing section is provided on the partition wall portion and the display unit.

2. The image pickup apparatus according to claim 1, wherein
the display unit is configured to be rotatable around the first rotation axis between a housed position in which the display unit is housed in the first housing section and an open position in which the display unit is pulled out from the first housing section, and
the holding mechanism comprises
a protrusion portion that protrudes from a wall surface of the partition wall portion facing the first housing section toward a first direction perpendicular to the wall surface and is disposed movably in the first direction;
a biasing member that is provided on the partition wall portion and is configured to bias the protrusion portion toward the first direction; and
a recess portion that is provided on a side surface of the display unit facing the partition wall portion when the display unit is in the housed position, and is engaged with the protrusion portion.

3. The image pickup apparatus according to claim 2, wherein
the protrusion portion has a first inclined surface and a second inclined surface that protrude toward the first direction, the first inclined surface and the second inclined surface forming a ridge line portion, and
when the display unit is in the housed position, the second inclined surface abuts on an opening end of the recess portion, and the display unit is biased in the first direction and in a direction toward the apparatus main body by the biasing member via the protrusion portion.

4. The image pickup apparatus according to claim 3, wherein
when the display unit is rotated from the open position to the housed position, the first inclined surface comes into line contact with the display unit.

5. The image pickup apparatus according to claim 3, wherein
the display unit is housed in the first housing section in a first housed state in which a display screen of the display unit faces a front of the apparatus main body, or a second housed state in which the display screen faces a rear of the apparatus main body, and
the recess portion is provided on each of a side surface of the display unit facing the partition wall portion when the display unit is in the first housed state and a side surface of the display unit facing the partition wall portion when the display unit is in the second housed state.

6. The image pickup apparatus according to claim 5, wherein
the display unit has a substantially rectangular shape when viewed from a direction perpendicular to the display screen of the display unit, and
the side surface of the display unit, on which the recess portion is provided, is a side surface on a long side of the display unit.

7. The image pickup apparatus according to claim 6, wherein
the recess portion is provided at a position that divides the side surface on the long side of the display unit approximately equally in a length direction of the display unit.

8. The image pickup apparatus according to claim 7, wherein
positions at which the second inclined surface abuts on the recess portion provided on the side surface on the long side of the display unit are positions that are approximately point-symmetric with respect to the second rotation axis when viewed from an axial direction of the second rotation axis.

9. The image pickup apparatus according to claim 8, wherein
a length over which the ridge line portion of the protrusion portion slides against the side surface of the display unit when the display unit is rotated from the second housed state to the open position is shorter than a length over which the ridge line portion of the protrusion portion slides against the side surface of the display unit when the display unit is rotated from the first housed state to the open position.

10. The image pickup apparatus according to claim 2, wherein
a rib, which protrudes from the wall surface of the partition wall portion facing the first housing section and slides against the display unit when the display unit is opened or closed, is provided on the wall surface.

11. The image pickup apparatus according to claim 10, wherein
the ribs are provided at two locations at a predetermined interval so as to sandwich the protrusion portion.

12. The image pickup apparatus according to claim 10, wherein
the rib and the apparatus main body are configured by different members.

13. The image pickup apparatus according to claim 1, wherein
an operation member for removing a battery that has been housed in the second housing section and an external connection terminal for performing connecting to an external device are provided on a rear surface of the apparatus main body,
the external connection terminal has a locking portion for preventing a connector connected to the external connection terminal from coming off, and
the locking portion is provided in a direction, which is different from a direction from the external connection terminal toward the second housing section, a direction from the external connection terminal toward the operation member, and a direction from the external connection terminal toward the display unit, when viewed from a rear of the apparatus main body.

14. The image pickup apparatus according to claim 13, wherein
the apparatus main body comprises
a gripping portion for a user to grip the image pickup apparatus;
an operation portion that is provided on a rear surface of the gripping portion; and
a projection portion that projects from the apparatus main body toward the rear of the apparatus main body adjacent to the operation portion, and
the external connection terminal is provided on a top surface of the projection portion.

15. The image pickup apparatus according to claim 1, further comprising:
a wireless antenna substrate that is disposed inside the partition wall portion, and
wherein when viewed from a rear of the image pickup apparatus to a front, the wireless antenna substrate does not overlap with a battery that has been housed in the second housing section and the display unit that has been housed in the first housing section.

16. The image pickup apparatus according to claim 15, wherein
the wireless antenna substrate and the display unit do not overlap with each other when viewed from a direction perpendicular to an image pickup surface of an image pickup device included in the image pickup apparatus, regardless of a position and a state of the display unit.

17. An image pickup apparatus comprising:
a display unit that has been attached to a rear surface side of an apparatus main body via a hinge having two rotation axes that are perpendicular to each other, and
wherein the apparatus main body comprises
a housing section for housing the display unit;
a wall portion that has a wall surface facing a side surface on a lower side of the display unit, which has been housed in the housing section, in a state where the image pickup apparatus is in a normal posture;
a protrusion portion that protrudes from the wall surface toward a first direction from a bottom surface of the apparatus main body toward a top surface of the apparatus main body and is disposed movably in the first direction; and
a biasing member that is configured to bias the protrusion portion toward the first direction,
the display unit comprises a recess portion that is engaged with the protrusion portion in a state where the display unit has been housed in the housing section, and
in a state where the protrusion portion and the recess portion are engaged with each other, the display unit is biased by the biasing member via the protrusion portion in the first direction and toward a rear surface of the apparatus main body.
